(19) United States
(12) Patent Application Publication
(10) Pub. No.: US 2002/0006021 A1
(43) Pub. Date: Jan. 17, 2002

(54) Spin valve sensor with an antiferromagnetic layer between two pinned layers

(76) Inventor: Robert S. Beach, Los Gatos, CA (US)

Correspondence Address: Robert B. O'Rourke, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/827,278

(22) Filed: Apr. 4, 2001

Related U.S. Application Data
(63) Continuation-in-part of application No. 09/615,158, filed on Jul. 13, 2000.

(51) Int. Cl. G11B 5/39

(52) U.S. Cl. 360/324.11; 29/603.14

(57) ABSTRACT

A multilayer structure is described having an antiferromagnetic layer between a first and second layer. The antiferromagnetic layer has antiferromagnetic coupling that helps pin the magnetization direction of the first layer and helps pin the magnetization direction of the second layer.

The present application is a continuation-in-part of U.S. application that has been provided application Ser. No. 09/615,158 and was filed on Jul. 13, 2000.

### FIELD OF THE INVENTION

The field of invention relates to direct access data storage, generally. More specifically, the invention relates to compensating for the effect of unwanted biasing from the pinned layer.

### BACKGROUND

Hardware systems often include memory storage devices having media on which data can be written to and read from. A direct access storage device (DASD or disk drive) incorporating rotating magnetic disks are commonly used for storing data in magnetic form. Magnetic heads, when writing data, record concentric, radially spaced information tracks on the rotating disks.

Magnetic heads also typically include read sensors that read data from the tracks on the disk surfaces. In high capacity disk drives, magnetoresistive (MR) read sensors, the defining structure of MR heads, can read stored data at higher linear densities than thin film heads. An MR head detects the magnetic field(s) through the change in resistance of its MR sensor. The resistance of the MR sensor changes as a function of the direction of the magnetic flux that emanates from the rotating disk.

One type of MR sensor, referred to as a giant magnetoresistive (GMR) effect sensor, takes advantage of the GMR effect. In GMR sensors, the resistance of the MR sensor varies with direction of flux from the rotating disk and as a function of the spin dependent transmission of conducting electrons between magnetic layers separated by a non-magnetic layer (commonly referred to as a spacer) and the accompanying spin dependent scattering within the magnetic layers that takes place at the interface of the magnetic and non-magnetic layers.

GMR sensors using two layers of magnetic material separated by a layer of GMR promoting non-magnetic material are generally referred to as spin valve (SV) sensors. In an SV sensor, one of the magnetic layers, referred to as the pinned layer, has its magnetization direction “pinned” via the influence of exchange anisotropy with an antiferromagnetic layer. Due to the relatively high internal anisotropy field associated with the pinned layer, the magnetization direction of the pinned layer typically does not rotate from the flux lines that emanate/terminate from/to the rotating disk. The magnetization direction of the other magnetic layer (commonly referred to as a free layer), however, is free to rotate with respect to the flux lines that emanate/terminate from/upon the rotating disk.

FIG. 1 shows a prior art SV sensor 100 comprising a seed layer 102 formed upon a gap layer 101. The seed layer 102 helps properly form the microstructure of the Antiferromagnetic (AFM) layer 105. Over seed layer 102 is a free layer 103. The Antiferromagnetic (AFM) layer 105 is used to pin the magnetization direction of the pinned layer 104. Pinned layer 104 is separated from free layer 103 by the non magnetic, GMR promoting, spacer layer 119. Note that free magnetic layer 103 may be a multilayer structure having two or more ferromagnetic layers.

A problem with structures such as the sensor 100 shown in FIG. 1, is the field biasing of the free layer 103. Specifically, since the pinned layer 104 has a net magnetic moment with associated pole densities, flux lines 107 are produced by the pinned layer 104 that (in the example of FIG. 1) exerts a bias on the free layer 103 in the +z direction. Ideally, the free layer 103 should experience minimal bias so that its magnetization (designed to point in the +x direction) has a balanced swing in the +z and −z directions. That is, a field from the disk in the +z direction should produce a magnetization swing in the +z direction that is the same as the magnetization swing observed in the −z direction from an identically strong field from the disk in the −z direction. The bias exerted by lines 107 adversely affect the balance of this swing.

### SUMMARY OF INVENTION

A multilayer structure is described having an antiferromagnetic layer between a first and second layer. The antiferromagnetic layer has antiferromagnetic coupling that helps pin the magnetization direction of the first layer and helps pin the magnetization direction of the second layer.

### BRIEF DESCRIPTION OF THE DRAWINGS

The present invention is illustrated by way of example, and not limitation, in the Figures of the accompanying drawings in which:

FIG. 1 shows a prior art SV sensor.

FIG. 2 shows an SV sensor having an antiferromagnetic layer between two pinned layers.

FIG. 3 shows a method that may be used to form the sensor shown in FIG. 2.

FIGS. 4 shows a biasing technique that may be used for an embodiment of the method shown in FIG. 3.

FIG. 5a shows a biasing technique that may be used for another embodiment of the method shown in FIG. 3.

FIG. 5b shows fields within the pinned layer and the pinned keeper layer from the setting current as well from an applied field for the technique shown in FIG. 5a.

FIG. 5c shows the net field within the pinned layer and keeper layer produced by the fields of FIG. 5b.

FIG. 6 shows a magnetic disk and activator.

FIG. 7 shows an air bearing surface.

FIG. 8 shows a direct access storage device.

### DETAILED DESCRIPTION

A multilayer structure is described having an antiferromagnetic layer between a first and second layer. The antiferromagnetic layer has antiferromagnetic coupling that helps pin the magnetization direction of the first layer and helps pin the magnetization direction of the second layer.

These and other embodiments of the present invention may be realized in accordance with the following teachings and it should be evident that various modifications and changes may be made in the following teachings without departing from the broader spirit and scope of the invention. The specification and drawings are, accordingly, to be regarded in an illustrative rather than restrictive sense and the invention measured only in terms of the claims.

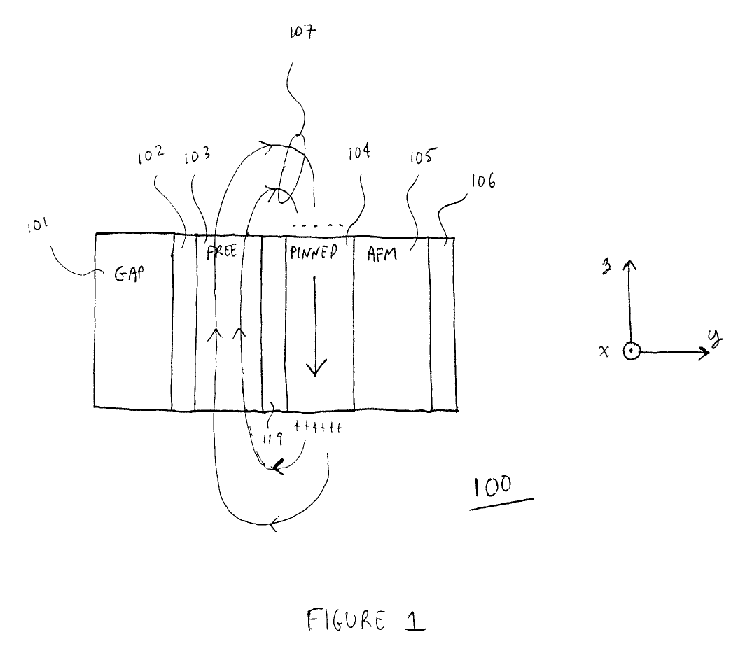

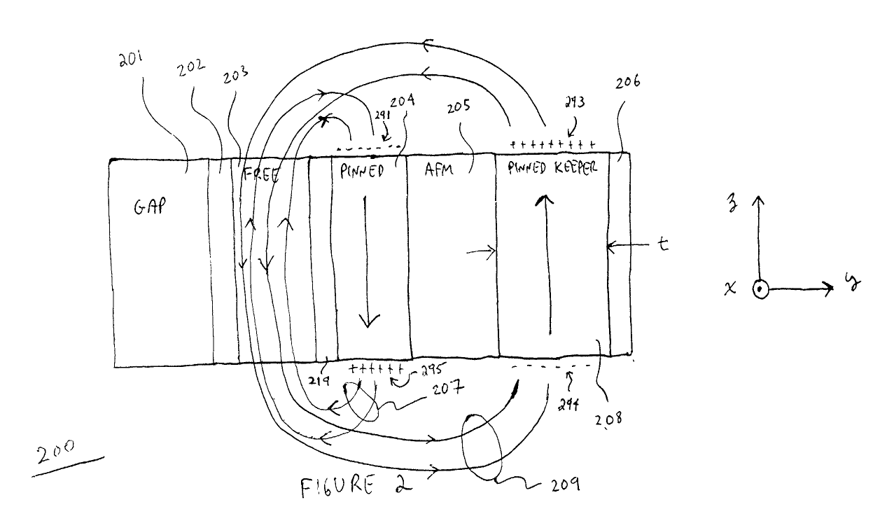

FIG. 2 shows sensor design 200 that improves upon the free layer 203 biasing problem discussed in the background. The SV sensor design 200 of FIG. 2 incorporates two pinned layers: pinned layer 204 and pinned keeper layer 208. The pinned layer 204 is used similarly to prior art SV sensors having a pinned layer 204. That is, pinned layer 204 is used to promote the GMR effect within the free layer 203 and, as such, is separated from the free layer 203 by a non magnetic spacer layer 219.

Pinned layer 204 produces flux lines 207, similar to the flux lines 107 discussed in the background with respect of FIG. 1, that (in the example of FIG. 2), exert a bias on the magnetization of the free layer 203 in the +z direction. Pinned keeper layer 208, however, is tailored to approximately cancel out the effect of flux lines 207 within the free layer 203.

As shown in FIG. 2, pinned keeper layer 208 has a magnetization direction that is antiparallel to the magnetization direction of the pinned layer 204. The antiparallel magnetization arrangement produces pole densities 293, 294 on either surface of the pinned keeper layer 208 that are opposite in polarity to the pole densities 291, 295 produced on the same surface on the sensor 200 at the pinned layer 204.

The flux lines 209 produced by the pinned keeper layer 208 are configured to approximately cancel the flux lines 207 produced by the pinned layer 204. This substantially removes any undesired bias on the free layer 203. As a result, the magnetization direction of the free layer 203 will be able to exhibit a balanced swing with respect to the flux that emanates/terminates from/upon the disk surface.

In order to substantially cancel out the flux lines 207 and 209 within the free layer 203, considerations should be taken into account of: 1) the total magnetic moment of the pinned layer 204 and the pinned keeper layer 208; and 2) the distance between the free layer 203 and the pinned layer 204; and 3) the distance between the free layer 203 and the pinned keeper layer 208. The total magnetic moment of each layer 204, 208 is determined by the thickness and material(s) of each layer 204, 208.

In one embodiment, gap layer 201 is an Al₂O₃ layer. Seed layer 202 is formed with 50 Å of Tantalum (Ta). Free layer 203 is formed with 50 Å of Ni₈₂Fe₁₈. Pinned layer 204 is a 50 Å layer of Co₉₀Fe₁₀. Anti Ferromagnetic layer 205 is a 200 Å layer of Platinum Manganese (PtMn). Pinned keeper layer 208 is formed with 70 Å of Co₉₀Fe₁₀. Cap layer 206 is formed with 50Å of Tantalum (Ta).

The antiparallel magnetization arrangement between the pinned layer 204 and the pinned keeper layer 208 may be obtained by “pinning”the magnetization direction of each of these layers 204, 208 through the exchange anisotropy coupling exerted by the antiferromagnetic layer 205. Exchange anisotropy is an effective field, associated with the lattice and atomic structure of an antiferromagnetic material, that causes the adjacent ferromagnetic layer moments to align preferentially in the “pinning” direction. Materials having the proper atomic and lattice structure to exhibit anisotropy coupling include IrMn, PtMn, NMn, NiO, CoO (or alloys of these materials) among others. Materials such as these may be used for antiferromagnetic layer 205. In order to exert the anisotropy coupling associated with the antiferromagnetic layer 205 upon its neighboring pinned 204 and pinned keeper 208 layers, the sensor (or at lease the portion having the antiferromagnetic 205, pinned 204 and pinned keeper 208 layers) may be heated above a “blocking” temperature with fields applied to the pinned 204 and pinned keeper 208 layer that are directed in the desired magnetization direction of these layers 204, 208. Note that neighboring layers are layers immediately next to one another.

Referring to FIG. 2, a field is applied to the pinned layer 204 in the −z direction and a field is applied to the pinned keeper layer 208 in the +z direction during the fabrication of the sensor. Once the structure is heated to a temperature above the blocking temperature, the structure is cooled while sustaining the applied fields to both layers 204, 208. As the structure cools below the blocking temperature, the applied fields force the antiferromagnetic coupling associated with the antiferromagnetic layer 205 to “set” in an orientation that promotes a magnetization direction in the −z direction for the pinned layer 204 and the +z direction for the pinned keeper layer 208.

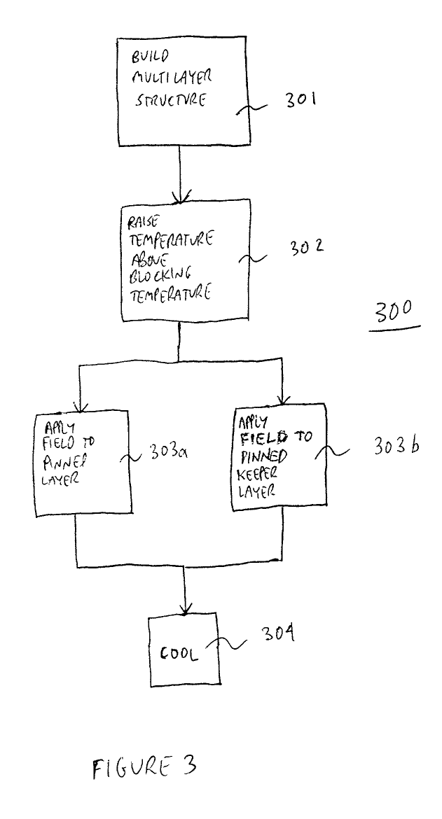

As such, after the sensor 200 is fully formed and installed in a DASD system, the anisotropy coupling of the antiferromagnetic layer 205 helps keep the magnetization of the pinned layer 204 “pinned” in the −z direction and the magnetization of the pinned keeper layer 208 “pinned” in the +z direction. FIG. 3 shows a methodology 300 consistent with the process discussed above. First, a multilayer structure is fabricated 301 comprising an antiferromagnetic layer between a pinned layer and a pinned keeper layer.

Then, the temperature of the multilayer structure is raised above the blocking temperature 302. Next, a field is applied to pinned layer 303a and a field is applied to the pinned keeper layer 303b. Alternatively, the fields may be applied 303a, 303b before the temperature is raised above the blocking temperature 302. The fields are applied in the desired direction of magnetization for these materials, which for the example shown in FIG. 2 corresponds to the −z direction for the pinned layer 204 and the +z direction for the pinned keeper layer 208. After the fields are applied 303a, 303b the multilayer structure is cooled 304.

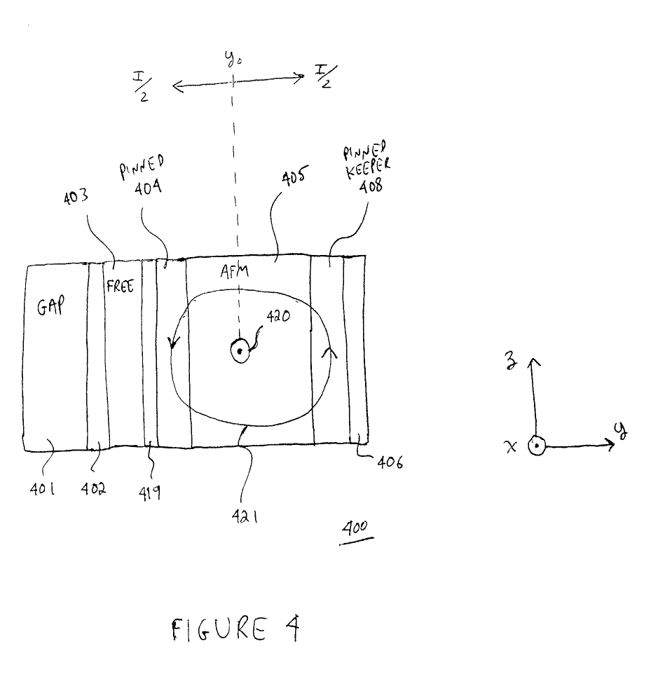

FIG. 4 relates to one fabrication embodiment of the method discussed with respect to FIG. 3. The sensor 400 of FIG. 4 corresponds to the basic SV sensor 200 of FIG. 2; thus, FIG. 4 relates to a processing embodiment that may be used to fabricate the basic SV sensor 200 of FIG. 2. However, the technique associated with FIG. 4 may be used with other SV sensor structures such as AP sensors and dual spin valve structures.

In FIG. 4, a setting current 420 in +x direction is sent through the sensor 400. Part of this current flows through the pinned keeper layer 408, part flows through layers to its left, and part flows through layer 406, to the right. The net field due to this current distribution acting on pinned layer 408 depends primarily on the net current to its right and the net current to its left. The fields due to current flow on the left and the right act in opposite directions, according to Ampere's law. The current field acting on pinned layer 404 is similarly determined.

In FIG. 4, the bulk of the current flows through AFM layer 405, generating flux line 421. The current distribution is such that the current fields acting on pinned keeper 408 and pinned layer 404 are antiparallel. As seen in FIG. 4, flux line 421 creates a field in the −z direction in the pinned layer 404 and a field in the +z direction in the pinned keeper layer 408. The minimum field strength used to set the antiferromagnetic coupling for both layers 404, 408 should be at or above the coercivity associated with each layer. For layers 408 formed with Co₉₀Fe₁₀, the coercivity is typically as low as 5.0 or as high as 30.0 Oersteds (Oe) with standard manufacturing techniques. Over time this range may change as storage densities increase.

The current distribution for a particular sensor structure is function of the resistivity of each layer and the thickness (i.e., width along the y axis) of each layer within the sensor 400. The individual layer resistances may be tailored to achieve a current distribution which produces the desired fields at the positions of the pinned (404) and pinned keeper (408) layers. For example, to increase the downward field acting on pinned layer 404, free layer 403 may be made thinner, or of a higher resistivity material, so that a greater fraction of the current flows to the right of pinned layer 404. Alternatively, the upward field acting on pinned keeper 408 may be increased by decreasing the thickness of layer 406. In the embodiments mentioned above, the resistance of the antiferromagnetic layer 405 could be less than the combined resistance of the sensor 400 regions outside the antiferromagnetic layer 405 to force most of the setting current 420 to flow in the antiferromagnetic layer 405.

The coercivities of the pinned and pinned keeper layers will be unequal, in general. It is desirable to adjust the current distribution such that the fields acting on the pinned and pinned keeper layers overcome the individual layer coercivities. For example, if the pinned layer 404 has a higher coercivity than the pinned keeper layer 408, layer 406 may be thickened to increase the downward field on pinned layer 404 while decreasing the upward field on pinned keeper 408. Similarly, spacer layer 419 may be thickened if the coercivity of the pinned keeper layer 408 is higher than the pinned layer 404.

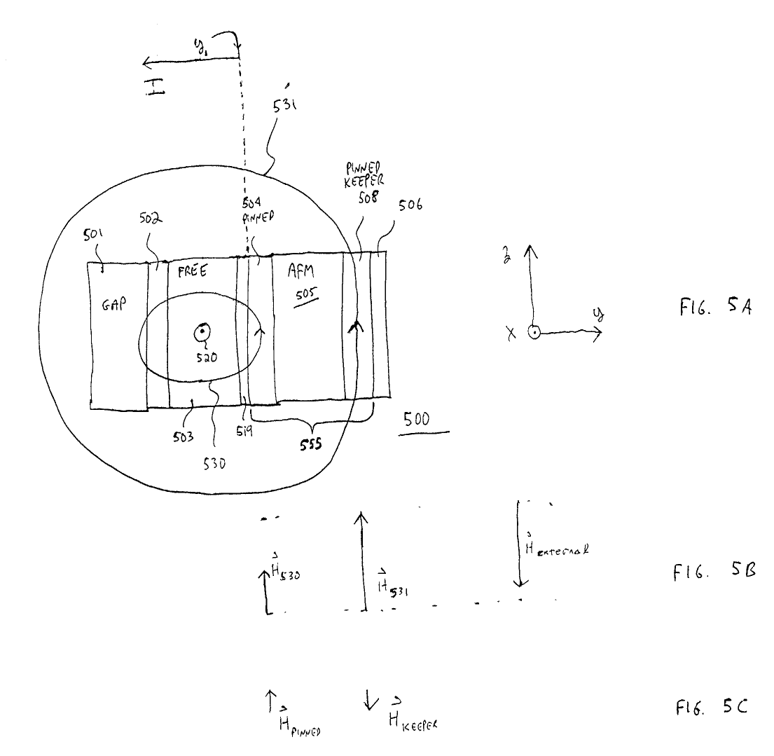

FIG. 5a relates to another embodiment of the method shown with respect to FIG. 3. In FIG. 5a, similar to FIG. 4, a setting current 520 is used to apply a field in the pinned 504 and pinned keeper 508 layers. In FIG. 5, the bulk of the current flows through the free layer 503, and generates flux line 530. In the embodiment of FIG. 5, it is the current field differential between pinned layer 504 and pinned keeper 508 which is made large, rather than the fields themselves. In addition to the current fields, another field is applied in order to properly orient the fields within the two layers 504, 508. This other applied field may be an external applied field.

Referring to FIGS. 5a and 5b, the field within the pinned layer 504 that results from setting current 520 is represented by vector H₅₃₀. Also, the field within the pinned keeper layer 508 that results from setting current 520 is represented by vector H₅₃₁. An applied external field is represented by vector Hₑₓₜₑᵣₙₐₗ. Note that, as seen in FIG. 5a, the setting current 520 is such that both fields H₅₃₀, H₅₃₁, created by the setting current 520 are oriented in the same direction (e.g., the +z direction).

Furthermore, of the two fields H₅₃₀, H₅₃₁ that result from the setting current 520, one field has a stronger intensity than the other. In the example of FIGS. 5a and 5b, field H₅₃₁, is stronger than field H₅₃₀. In order to form one field stronger than another field with a setting current 520, the setting current 520 may be partly confined outside the antiferromagnetic layer 505 (e.g., outside the multilayer structure 555 formed by the pinned layer 504, antiferromagnetic layer 505 and pinned keeper layer 508).

By partly confining the setting current through the sensor outside the antiferromagnetic layer 505, the stronger field (e.g., H₅₃₁) may be formed in the layer further from the confined setting current (e.g., layer 508) and the weaker field (e.g., H₅₃₀) may be formed in the layer closer to the confined setting current (e.g., layer 504). Thus, in the embodiment of FIG. 5a, the resistivity of each of the various sensor 500 layers may be configured to confine the setting current 520 to flow substantially on one side of the multilayer structure 555 having the pinned 504, AFM 505 and pinned keeper 508 layers such that the field strength continually increases as the distance from the side of the multilayer structure having the substantial amount of setting current increases. Specifically, in the sensor embodiment 500 of FIG. 5a, the setting current 520 substantially flows to the “left” of position y1.

The setting current may be partly confined in this manner by tailoring the resistivity of each of the layers within the sensor 500 and their associated thickness appropriately. For example, a thicker free layer 503 comprised of CoFe and/or NiFe promotes current confinement to the left of y1 as does an antiferromagnetic 505 layer comprised of a highly resistive material (e.g., an oxide such as NiO or CoO).

Alternate sensor embodiments may be designed to confine the setting current partly to the “right” of multilayer structure 555. Note that in still other sensor embodiments, the setting current may flow in the pinned 504 and pinned keeper 508 layers, provided the difference in field magnitude between fields H₅₃₀, H₅₃₁, and the uniformity in field direction of fields H₅₃₀, H₅₃₁ is not substantially disturbed.

In yet other embodiments, considerable current may flow through the antiferromagnetic layer 505 provided there is sufficient current outside the antiferromagnetic layer to properly bias layers 504, 506. That is, if the resistance of the antiferromagnetic layer 505 is sufficiently greater than the combined resistance of the sensor 500 through the regions on either side of the antiferromagnetic layer 505 (e.g., the region to the left of the antiferromagnetic layer 505 or the region to the right of the antiferromagnetic layer 505 as seen in FIG. 5a) layers 504 and 508 may be properly biased as in FIG. 5c.

FIG. 5c shows the resultant field within the pinned layer H_{pinned} and the pinned keeper layer Hₖₑₑₚₑᵣ. H_{pinned} is the vector addition of H₅₃₀and Hₑₓₜₑᵣₙₐₗ of FIG. 5b. Hₖₑₑₚₑᵣ is the vector addition of H₅₃₁ and Hₑₓₜₑᵣₙₐₗ of FIG. 5b. The magnitude of Hₑₓₜₑᵣₙₐₗ should be greater than one field (e.g., H₅₃₀) produced by the setting current yet smaller than the other field (e.g., H₅₃₁) produced by the setting current. This relationship will force the resultant field H_{pinned}within the pinned layer 504 to be antiparallel to the resultant field Hₖₑₑₚₑᵣ within the pinned keeper layer 508. When the proper resultant fields are established in the pinned 504 and pinned keeper layers 508, the sensor 500 may be cooled from a temperature above the antiferromagnetic blocking temperature to a temperature below this temperature in order to properly orient the antiferromagnetic coupling. Typical blocking temperatures range from 200 to 400° C. Note, however, that the blocking temperature is a function of material and other physical parameters (e.g., lattice structure) which may affect this range from embodiment to embodiment.

Still other embodiments of FIG. 3 may differ slightly from those discussed above by incorporating a hard magnetic layer (e.g., a material exhibiting permanent magnet characteristics such as a high coercivity) as either the pinned layer or pinned keeper layer or as both layers. The hard magnetic layer(s) may have its magnetization direction permanently set by an applied field that is greater than the layer's coercivity.

When the magnetization direction of the hard magnetic layer is permanently set, the temperature of the sensor may be lowered from above the antiferromagnetic blocking temperature to below it. Note that in order to employ this approach the curie temperature of the hard magnetic layer should be greater than the blocking temperature of the antiferromagnetic coupling field. This is true in most cases since typical hard magnetic materials have curie temperatures above 500° C.

Referring to FIGS. 2, 4 and 5, it is important to note that the gap layer 201, 401, 501 may be comprised of any oxide layer used within MR structures such as NiMnO, NiMgO₂, and Al₂O₃among others. Furthermore, seed layer 202, 402, 502 may be formed with magnetic materials such as a Co based alloy (e.g., CoFe) or non magnetic materials such as Ta or Cu. Note that if magnetic seed layers 302, 402 are used, the effect of its associated pole density and corresponding magnetic field (if any or if noticeable) on the biasing of the free, pinned and pinned keeper layers may have to be accounted for in the design of the sensor 300, 400. Cu, Au, Ag or Ru may be used for the non magnetic and spacer layer 219, 419, 519. Free layer 203, 403, 503 is typically comprised of CoFe or NiFe or alloys thereof. Note that consistent with the skills of those who practice in the art, embodiments employing CoFe and NiFe are not limited solely to Co₉₀Fe₁₀ and Ni₈₂Fe₁₈. That is, element percentages may vary consistent with the general formulations: CoₓFe_{x-1 and Ni}ₓFeₓ₋₁.

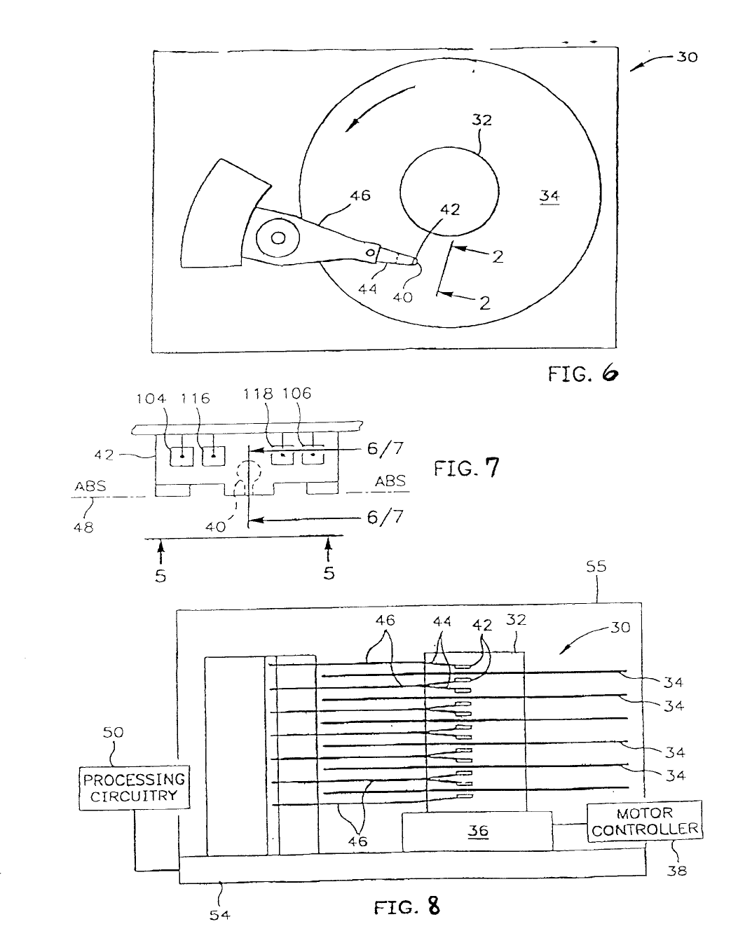

Referring now to the drawings wherein like reference numerals designate like or similar parts throughout the several views, FIGS. 6-8 illustrate a magnetic disk drive 30. The drive 30 includes a spindle 32 that supports and rotates a magnetic disk 34. The spindle 32 is rotated by a motor 36 that is controlled by a motor controller 38. A slider 42 with a combined read and write magnetic head 40 is supported by a suspension 44 and actuator arm 46. A plurality of disks, sliders and suspensions may be employed in a large capacity direct access storage device (DASD) as shown in FIG. 8. The suspension 44 and actuator arm 46 position the slider 42 so that the magnetic head 40 is in a transducing relationship with a surface of the magnetic disk 34. When the disk 34 is rotated by the motor 36 the slider is supported on a thin (typically, 0.05 μm) cushion of air (air bearing) between the surface of the disk 34 and the air bearing surface (ABS) 48. The magnetic head 40 may then be employed for writing information to multiple to multiple circular tracks on the surface of the disk 34, as well as for reading information therefrom. Processing circuitry 50 exchanges signals, representing such information, with the head 40, provides motor drive signals for rotating the magnetic disk 34, and provides control signals for moving the slider to various tracks.

What is claimed is:

1. An apparatus, comprising:
a multilayer structure having an antiferromagnetic layer between a first and second layer, the antiferromagnetic layer having exchange anisotropy that helps pin the magnetization direction of the first layer and helps pin the magnetization direction of the second layer.

2. The apparatus of claim 1 wherein said magnetization direction of said first layer is antiparallel to said magnetization direction of said second layer.

3. The apparatus of claim 1 wherein said first layer neighbors said antiferromagnetic layer.

4. The apparatus of claim 1 wherein said second layer neighbors said antiferromagnetic layer.

5. The apparatus of claim 1 wherein said first and second layers neighbor said antiferromagnetic layer, said multilayer structure part of a larger multilayer structure having a free layer, said first layer a pinned layer, said second layer a pinned keeper layer, said pinned layer producing first pole densities and resulting first field that are approximately canceled by a second field within said free layer resulting from second pole densities produced by said pinned keeper layer.

6. The apparatus of claim 5 wherein the resistance associated with each of the layers of said larger multilayer structure is such that most of the current flow through said sensor flows through said antiferromagnetic layer.

7. The apparatus of claim 6 wherein said current flow is centered along the thickness of said antiferromagnetic layer.

8. The apparatus of claim 5 wherein the resistance associated with each of the layers of said larger multilayer structure are such that more current flows through said sensor outside said antiferromagnetic layer than inside said antiferromagnetic layer.

9. The apparatus of claim 8 wherein said antiferromagnetic layer material is an oxide.

10. The apparatus of claim 5 wherein said pinned layer and/or said pinned keeper layer is a hard magnetic layer.

11. An apparatus, comprising:
a) a disk; and
b) a head configured to be disposed over said disk, said head comprising, a multilayer structure having an antiferromagnetic layer between a first and second layer, the antiferromagnetic layer having exchange anisotropy that helps pin the magnetization direction of the first layer and helps pin the magnetization direction of the second layer.

12. The apparatus of claim 1 wherein said magnetization direction of said first layer is antiparallel to said magnetization direction of said second layer.

13. The apparatus of claim 1 wherein said first layer neighbors said antiferromagnetic layer.

14. The apparatus of claim 1 wherein said second layer neighbors said antiferromagnetic layer.

15. The apparatus of claim 1 wherein said first and second layers neighbor said antiferromagnetic layer, said multilayer structure part of a larger multilayer structure having a free layer, said first layer a pinned layer, said second layer a pinned keeper layer, said pinned layer producing first pole densities and resulting first field that are approximately canceled by a second field within said free layer resulting from second pole densities produced by said pinned keeper layer.

16. The apparatus of claim 5 wherein the resistance associated with each of the layers of said larger multilayer structure is such that most of the current flow through said sensor flows through said antiferromagnetic layer.

17. The apparatus of claim 6 wherein said current flow is centered along the thickness of said antiferromagnetic layer.

18. The apparatus of claim 5 wherein the resistance associated with each of the layers of said larger multilayer structure are such that more current flows through said sensor outside said antiferromagnetic layer than inside said antiferromagnetic layer.

19. The apparatus of claim 8 wherein said antiferromagnetic layer material is an oxide.

20. A method comprising:
cooling a multilayer structure having an antiferromagnetic layer from a temperature above an antiferromagnetic blocking temperature to a temperature below said antiferromagnetic blocking temperature while a first magnetic field is established within a first layer to pin the magnetization direction of said first layer and while a second magnetic field is established within a second layer to pin the magnetization direction of said second layer.

21. The method of claim 20 wherein said first field is antiparallel to said first field.

22. The method of claim 21 wherein said first and second fields are formed by directing a current through said multilayer structure, said first and second fields antiparallel to each other.

23. The method of claim 21 wherein said first and second fields are at least partially formed by directing more current outside said multilayer structure than inside said multilayer structure.

24. The method of claim 23 further comprising applying an external magnetic field, said external magnetic field fully forming said first and second magnetic fields when combined with fields produced by said current.
